(19) United States
(12) Patent Application Publication
(10) Pub. No.: US 2006/0239430 A1
(43) Pub. Date: Oct. 26, 2006

(54) Systems and methods of providing online protection

(76) Inventors: Robert Gue, Atlanta, GA (US); Edward Seitz, Atlanta, GA (US)

Correspondence Address: BROWN, RAYSMAN, MILLSTEIN, FELDER & STEINER LLP, 900 THIRD AVENUE, NEW YORK, NY, 10022, US

(21) Appl. No.: 11/408,568

(22) Filed: Apr. 21, 2006

Related U.S. Application Data
(60) Provisional application No. 60/673,901, filed on Apr. 21, 2005.

(51) Int. Cl. H04M 3/42

(52) U.S. Cl. 379/201.05; 379/201.01

(57) ABSTRACT

The present invention describes system and methods for warning users of or blocking access to known or suspected illegitimate or nefarious resources prior to accessing the requested resource. The system of the present invention maintains one or more data structures containing lists of legitimate, illegitimate and suspicious online and local resources, as well as characteristics thereof. The system compares the user requested resource against the lists of legitimate, illegitimate and suspicious resources and characteristics thereof and determines an appropriate resolution to the request, e.g., whether or not to allow user access to the requested resource.

The present application claims the benefit of U.S. Provisional Patent Application No. 60/673,901, entitled “SYSTEMS AND METHODS OF PROVIDING ONLINE PROTECTION,” filed on Apr. 21, 2005, attorney docket number 7346/38P, the disclosure of which is hereby incorporated by reference herein in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### FIELD OF THE INVENTION

This invention relates generally to providing online protection, and in particular to protecting users from websites which gather or disseminate user information through deception, without authorization or without user knowledge.

### BACKGROUND OF THE INVENTION

As users increasingly engage in online commerce and other activities that involve divulging one's personal information, the chances of such information being collected or disseminated through deception, without authorization and without user permission also increases. While such personal information may include the mundane (e.g., age, gender, occupation), many times it also includes highly sensitive information as well (e.g., social security number, credit card number, password, etc.). A common scheme to collect and illegally disseminate personal information is a scheme known as “phishing.” Phishing is the process of gathering personal information online for unauthorized use. Phishing attempts often begin with an unsolicited email to a user. The email is intended to lure the user to a website where personal information is then requested. Some phishing schemes are so elaborate that the web address or web pageto which the user is directed may be disguised to appear similar to the address of a well known legitimate website.

While the user may think he/she is providing their personal information for some stated limited or legitimate purpose (e.g., validating bank account information, validating online auction account, enter a contest, receive a free membership, etc.), the information may actually be collected and used for any number of nefarious reasons.

There are currently only limited methods for alerting users about websites, which are known or suspected of being used for illegitimate purposes. Accordingly, there is a need for a system and methods that protect users from the aforementioned online dangers.

### SUMMARY OF THE INVENTION

In various embodiments of the present invention disclosed herein are systems and methods for protecting online users from accessing or visiting illegitimate online resources, which may also include local resources on a client device (desktop computer, PDA, etc.). For example, such online resources may be known or suspected to solicit personal information for unauthorized uses (e.g., phishing). In one embodiment, the online resource may be a website. In other embodiments, the online resource may also be located via FTP, Internet protocols, socket-based and other network and local communications.

In accordance with one embodiment, the system of the present invention maintains one or more data structures containing lists of legitimate, illegitimate and suspicious online resources, which may include characteristics regarding the same, e.g., patters of legitimate, illegitimate and suspicious local and remote resources. Hereinafter the lists of legitimate online resources will be referred to as a greenlist and the lists of illegitimate online resources will be referred to as a blacklist. The greenlist or blacklist may be stored in one or more cached data structures, locally maintained data structures, remotely maintained data structures, or any combination thereof. In one embodiment, a given cached data structure may contain resource entries encountered during the current user session, while given a locally maintained data structure may contain cumulative resource entries for a given user or usersover a plurality of sessions. It should be appreciated that the use of one or more cached data structures and one or more locally maintained data structures may increase processing efficiency, but is not required.

The system is operative to receive user request for an online resource, which may comprise a pointer to the online resource. A pointer as used herein may be any reference to a local or remote resource. In one embodiment, the pointer may be a website address, uniform resource identifier (URI), uniform resource locator (URL), a file transfer protocol (FTP) address, or any other location convention which may be used to locate an online resource.

In one aspect of the invention, the system is operative to compare the resource associated with the provided pointer against a list of known legitimate resources stored in a greenlist data structure. If the requested online resource is listed in the greenlist data structure, then the user may be allowed to safely navigate to the requested resource.

However, if the requested resource is not listed in the greenlist database, then in another aspect of the invention, the system is operative to compare the resource associated with the provided pointer against a list of known illegitimate resources stored in a blacklist data structure. If the requested online resource is listed in the blacklist data structures, the user may then be provided with a notification warning before being allowed to navigate to the requested resource. Alternatively, the user may be prevented from navigating to the requested resource. In one embodiment, a warning message may comprise a warning web page describing the potential problem.

Another aspect of the invention is to compare characteristics of the provided pointer with known characteristics of pointers used for illegitimate resources. If this “pattern matching” operation indicates that the provided pointer exhibits questionable characteristics indicative of a potential illegitimate resource, then an exceptions list (or false-positives database) may be consulted to see if the questionable resource has been previously cleared. If the resource in question does not appear on the exceptions list, then the user may be blocked from accessing the resource or provided with a warning before being allowed to navigate to the requested resource. In one embodiment, navigating the user to a web page describing the potential problem may provide the warning. The exceptions list may be regularly updated with resources that are determined to be legitimate non-malicious resources, which may include characteristics regarding the same.

In yet another embodiment, the context in which the pointer (e.g., URI, URL, etc.) in question is being used may be analyzed to determine the legitimacy of the requested resource. For example, if the pointer is contained in hypertext markup language (HTML), anchor tag analysis may be performed to determine if the pointer is potentially being misrepresented.

Still another aspect of the invention is to query, in real-time, a database to determine if a resource's previous status, e.g., legitimate, illegitimate or neither, should be updated. In addition, automatic reporting or manual reporting by users may be used to update the blacklist data structure, greenlist data structure and/or the exceptions data structure.

In one embodiment, the systems and methods of the present invention may be provided on the client-side, on the sever-side or distributed between the client and server. In the case of a client-side implementation, the invention may be implemented as a browser add-in, a browser helper object, a layered service provider, a software driver, network drivers, a separate hardware device or into the browser itself, or any other method to build applications, extensions, plug-ins, script, etc. on the platform. Similarly, one or more of the data structures described herein may be maintained on the client-side or on the server-side.

It should further be appreciated that determinations as to whether a given online resource is legitimate or not may not be absolute. In other words, a questionable resource may be assigned a score, which may include a measure, grade, category, level, probability, etc., indicating the likelihood that the questionable resource is illegitimate. Thus, rather than indicating to a user that a requested resource is not a legitimate resource, the user may simply be informed of the likelihood of the danger as indicated by the score. In another embodiment, a resource may be added to a blacklist when a predetermined threshold for how likely it is to be illegitimate is exceeded.

In accordance with the practices of persons skilled in the art of computer programming, the invention is described below with reference to symbolic representations of operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations such as in system memory, as well as other processing of signals. The memory locations where data bits are maintained are physical locations that have particular electrical, magnetic, optical, or organic properties corresponding to the data bits. Thus, the term “server” is understood to include any electronic device that contains a processor, such as a central processing unit.

When implemented in software, the elements of the invention are essentially the code segments to perform the necessary tasks. The program or code segments can be stored in a processor readable medium or transmitted by a computer data signal embodied in a carrier wave over a transmission medium or communication link. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

As discussed herein, a “computer” or “computer system” is a product including circuitry capable of processing data. The computer system may include, but is not limited to, general-purpose computer systems (e.g., server, laptop, desktop, palmtop, personal electronic devices, etc.), personal computers (PCs), hard copy equipment (e.g., printer, plotter, fax machine, etc.), banking equipment (e.g., an automated teller machine), and the like. In addition, a “communication link” refers to the medium or channel of communication. The communication link may include, but is not limited to, a telephone line, a modem connection, an Internet connection, a digital subscriber line (DSL), an Integrated Services Digital Network (“ISDN”) connection, an Asynchronous Transfer Mode (ATM) connection, a frame relay connection, an Ethernet connection, a coaxial connection, a fiber optic connection, satellite connections (e.g. Digital Satellite Services, etc.), wireless connections, radio frequency (RF) links, electromagnetic links, two way paging connections, etc., and combinations thereof.

### BRIEF DESCRIPTION OF THE DRAWINGS

FIG. 1 depicts one embodiment of a system level diagram showing the interconnectivity of one or more aspects of the invention;

FIG. 2 depicts one embodiment of a system level diagram of a computer system usable to implement one or more aspects of the invention;

FIGS. 3A-3C depict one embodiment of a flow diagram for implementing one or more aspects of the invention;

FIG. 4 illustrates one embodiment of a graphical user interface displaying a warning to a user in accordance with the principles of the invention;

FIG. 5 illustrates another embodiment of a graphical user interface displaying a warning to a user in accordance with the principles of the invention;

FIG. 6 illustrates yet another embodiment of a graphical user interface displaying a warning to a user in accordance with the principles of the invention; and

FIG. 7 illustrates still another embodiment of a graphical user interface displaying a warning to a user in accordance with the principles of the invention.

### DETAILED DESCRIPTION OF THE INVENTION

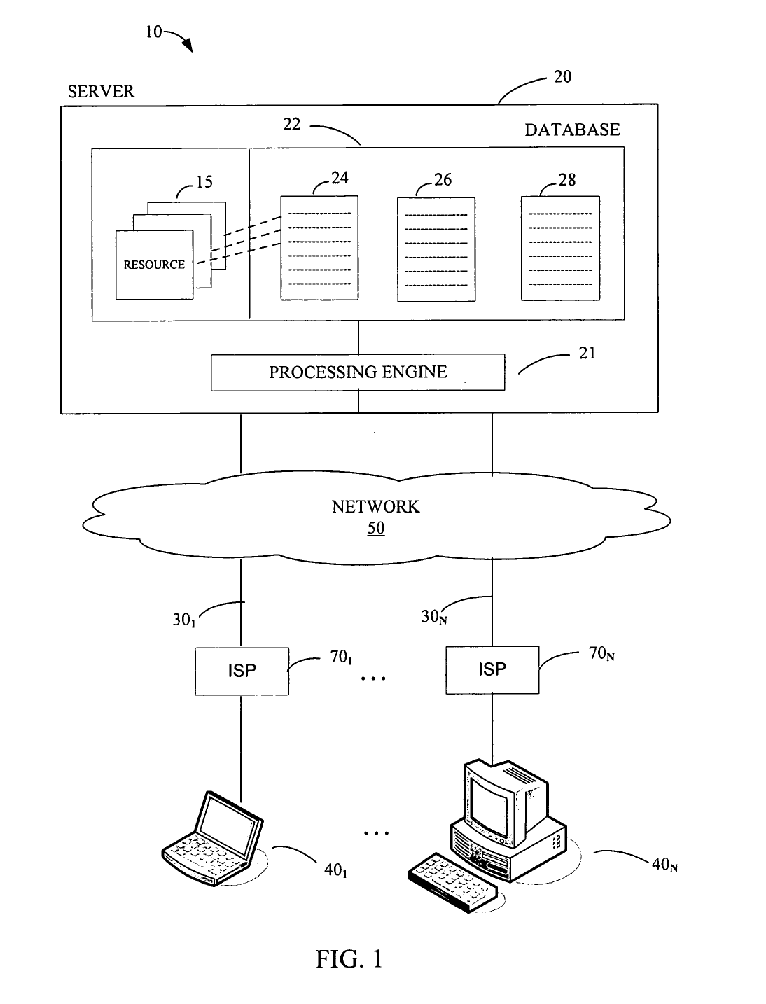

FIG. 1 shows a system block diagram of one embodiment of an information distribution system 10 in which the systems and methods of the present invention may be used. In the embodiment of FIG. 1, system 10 comprises a remote server 20 that may be connected over one or more communications links 30₁-30_{N} (“30”) through a remote network 50 (e.g., the Internet) to one or more user computer systems 40₁-40_{N} (“40”). The remote server 20 may include computer readable instructions for providing in response to the requests form user computer systems 40 one or more target resources 15 during user sessions. In one embodiment, the remote server 20 may further include one or more databases 22 for storing data such as, for example, user data and/or target resources 15. While for brevity remote server 20 is referred to in the singular, it should equally be appreciated that remote server 20 may be comprised of a plurality of individual computers or servers.

In one embodiment, the database 22 may further comprise one or more data structures containing lists of legitimate 24, illegitimate 26 and suspicious 28 online resources. Hereinafter the lists of legitimate online resources 24 will be referred to as a “greenlist” and the lists of illegitimate online resources 26 will be referred to as a “blacklist”. The greenlist and/or blacklist may be comprised of one or more cached data structures, locally maintained data structures, remotely maintained data structures, or any combinations thereof. In one embodiment, a given cached data structure may contain resource entries encountered during a current user session, while a locally maintained database may contain cumulative resource entries for a given user or users over a plurality of sessions. It should be appreciated that the use of cached database and locally maintained databases may increase processing efficiency, but is not required.

In one embodiment, the server 20 further comprises a processing engine 21 operative to process requests for one or more target resources 15 form user computer systems 40 according to the methods of the present invention disclosed herein. In particular, the processing engine 21 is operative to receive user request for an online resource 15, which may comprise a pointer to the online resource 15. In one embodiment, the pointer may be a website address, uniform resource identifier (URI), uniform resource locator (URL), a file transfer protocol (FTP) address, or any other location convention which may be used to locate either online or local resources.

In one aspect of the invention, the processing engine 21 is operative to compare the resource associated with the provided pointer against the list of pointers for known legitimate resources, or characteristics thereof, stored in the greenlist data structure 24. If the requested online resource 15 is listed in the greenlist data structure 24, then the user may safely navigate to the requested resource 15.

In the event the requested resource 15 is not listed in the greenlist data structure 24, then in another aspect of the invention, the processing engine 21 is operative to compare the resource associated with the provided pointer against the list of pointers of known illegitimate resources, which may include characteristics thereof, stored in the blacklist data structure 26. If the requested online resource is listed in the blacklist data structure 26, the user may then be provided with a warning message before being allowed to navigate to the requested resource 15. In one embodiment, the warning message may comprise a warning web page describing the potential problem with the requested resource 15.

Yet in another embodiment, the processing engine 21 is operative to compare various characteristics of the provider pointer with known characteristics of pointers used for illegitimate resources, the operation hereinafter referred to as “pattern matching.” If the pattern matching operation indicates that the provided pointer exhibits questionable characteristics indicative of a potential illegitimate resource, then the processing engine 21 is operative to consult an exceptions list stored in data structure 28 to determine if the questionable resource 15 has been previously cleared. If the resource in question does not appear on the exceptions list 28, then the user may be provided with a warning message before being allowed to navigate to the requested resource. Alternatively, the user may be prevented from navigating to the requested resource. In one embodiment, the warning message may comprise a web page describing the potential problem with the requested resource. The exceptions list 28 may be regularly updated with resources that are determined to be legitimate non-malicious resources.

The processing engine 21 may further be operative determine in absolute terms whether a given online resource is legitimate or not. To that end, the processing engine 21 may assign to the questionable resource a score indicating how the likelihood that the questionable resource is illegitimate. Thus, rather than indicating to a user that a requested resource is not a legitimate resource, the user may simply be informed of the likelihood of the danger, which may be indicated as a score, level, category, probability, etc. In another embodiment, the processing engine 21 may add a questionable resource to a blacklist data structure 26 when a predetermined threshold for how likely it is to be illegitimate is exceeded.

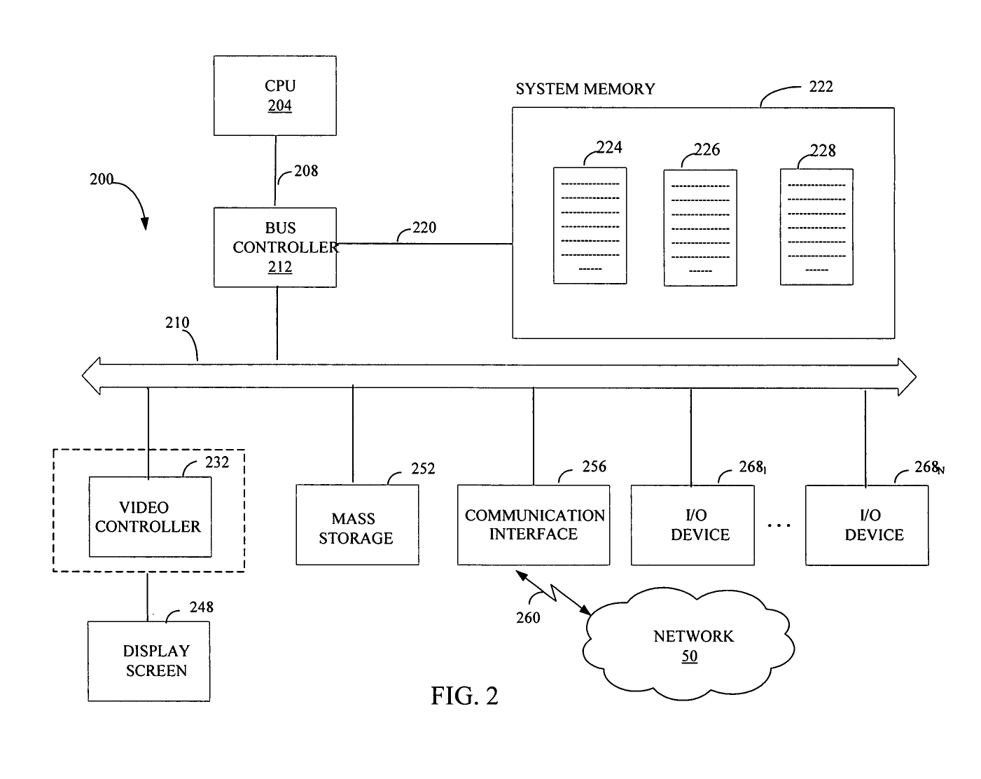

Referring to FIG. 2, depicted is one embodiment of the type of computer system, which may comprise the one or more user computers 40 of FIG. 1. In particular, computer system 200 comprises a processor or a central processing unit (CPU) 204, which may include an arithmetic logic unit (“ALU”) for performing computations, a collection of registers for temporary storage of data and instructions, and a control unit for controlling operation for the system 200. In one embodiment, the CPU 234 includes any one of the x86, Pentium™ class microprocessors as marketed by Intel Corporation, microprocessors as marketed by AMD™, or the 6×86MX microprocessor as marketed by Cyrix™ Corp. In addition, any of a variety of other processors, including those from Sun Microsystems, MIPS, IBM, Motorola, NEC, Cyrix, AMD, Nexgen and others may be used for implementing CPU 204. Moreover, the CPU 204 is not limited to microprocessors but may take on other forms such as microcontrollers, digital signal processors, reduced instruction set computers (RISC), application specific integrated circuits, and the like. Although shown with one CPU 204, it should equally be appreciated that computer system 200 may alternatively include multiple processing units.

The CPU 204 is coupled to a bus controller 212 by way of a CPU bus 208. The bus controller 212 may include a memory controller integrated therein, although the memory controller may be external to the bus controller 212. In one embodiment, the system memory 222 may be coupled to the bus control 212 via a memory bus 220, where the system memory 222 may include synchronous dynamic random access memory (“SDRAM”). System memory 122 may optionally include any additional or alternative high-speed memory device or memory circuitry. The bus controller 212 is coupled to a system bus 210 that may be a peripheral component interconnect (“PCI”) bus, Industry Standard Architecture (“ISA”) bus, etc. Coupled to the system bus 210 are a graphics controller, a graphics engine or a video controller 232, a mass storage device 252, a communication interface device 256, one or more input/output (“I/O”) devices 268₁-268_{N}. The video controller 232 may be coupled to a video memory and video BIOS, all of which may be integrated onto a single card or device. The video memory may be used to contain display data for displaying information on the display screen 248, and the video BIOS may include code and video services for controlling the video controller 232. In another embodiment, the video controller 232 may be coupled to the CPU 204 through an advanced graphics port (“AGP”) bus (not shown).

The mass storage device 252 may include (but not be limited to) a hard disk, floppy disk, CD-ROM, DVD-ROM, tape, high density floppy, high capacity removable media, low capacity removable media, solid state memory device, etc., and combinations thereof. The mass storage device 252 may further include any other mass storage medium. The communication interface device 256 may include a network card, a modem interface, etc. for accessing network 50 via communications link 260. The I/O devices 268₁-268_{N} include a keyboard, mouse, audio/sound card, printer, and the like. The I/O device 268₁-268_{N} may be a disk drive, such as a compact disk drive, a digital disk drive, a tape drive, a zip drive, a jazz drive, a digital video disk (DVD) drive, a solid state memory device, a magneto-optical disk drive, a high density floppy drive, a high capacity removable drive, a low capacity media device, and/or any combination thereof.

As depicted in FIG. 2, the system memory 222 may further comprise one or more data structures containing lists identifying legitimate 224, illegitimate 226 and suspicious 228 online resources, which may also identify characteristics thereof. In one embodiment, the lists contained in the data structures 224, 226, and 228 may comprise a portion of the items contained in data structures 24, 26 and 28 stored in the database 22 on the remote server 20. In alternative embodiment, the lists contained in the data structures 224, 226, and 228 may completely replicate the lists stored in the data structures 24, 26 and 28. Yet in another embodiment, the system of the present invention may maintain the entire lists identifying legitimate 224, illegitimate 226 and suspicious 228 online resources in the memory 222 of the user computer system 200 only.

As is familiar to those skilled in the art, the computer system 200 may further includes an operating system (OS) and at least one application program, which in one embodiment, are loaded into system memory 224 from mass storage device 252. The OS may include any type of OS including, but not limited or restricted to, DOS, Windows, Unix, Linux, Xenix, etc. The operating system is a set of one or more programs which control the computer system's 200 operation and the allocation of resources. The application program is a set of one or more software programs that performs a task desired by the user.

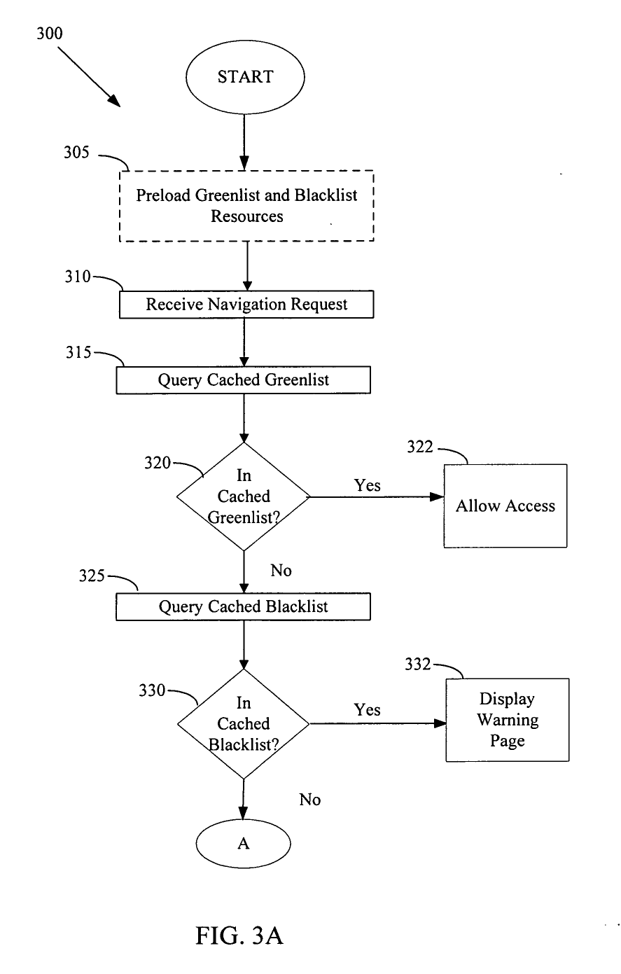

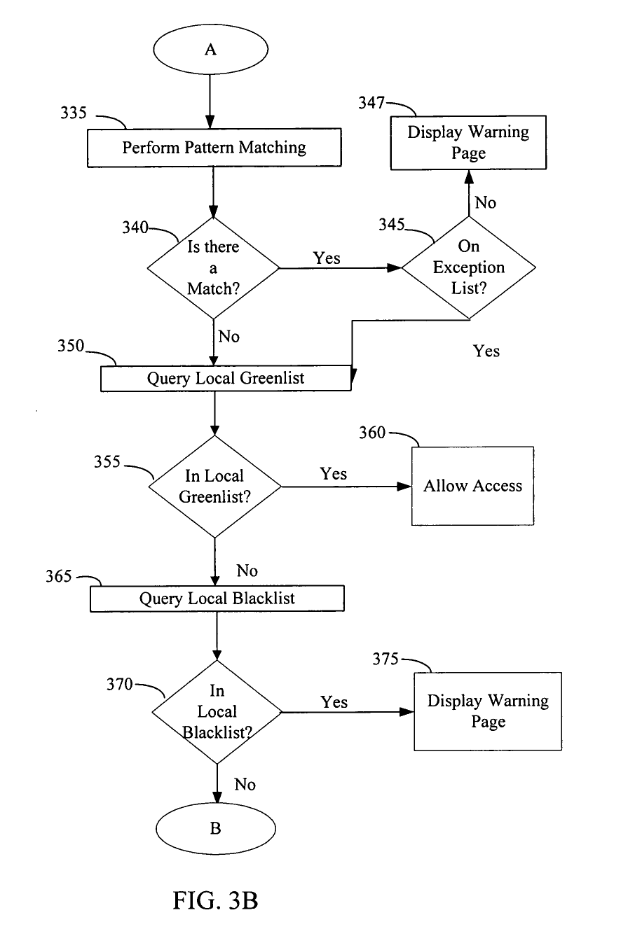

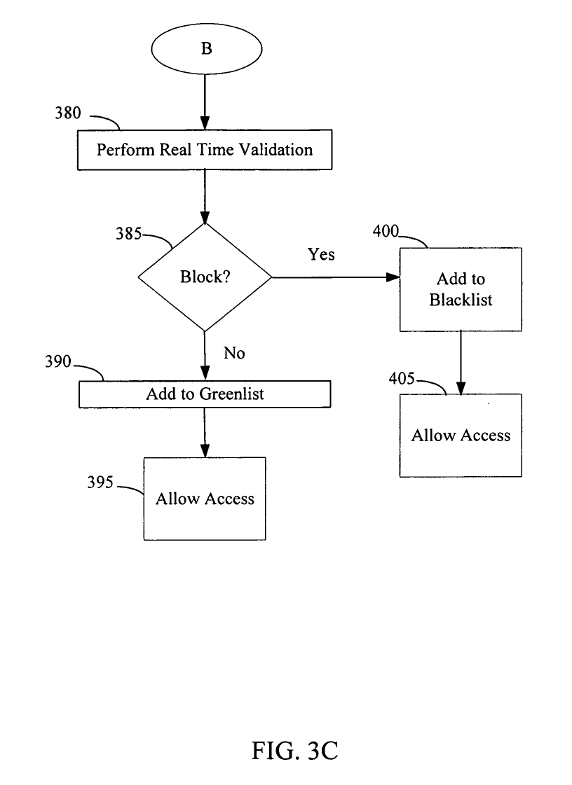

Referring now to FIGS. 3A-3C, depicted is one embodiment of a flow diagram for implementing one or more aspects of the invention. Process 300 makes use of one or more greenlist data structures that maintain a list of resources known to be valid resources. Process 300 further makes use of one or more blacklist data structures that maintain lists of resources, as well as characteristics thereof, that are known or suspected as being used for illegitimate purposes. In addition, an exceptions list data structure may be maintained with a list of resources that have been verified as legitimate resources, despite the fact that their associated pointers may contain characteristics matching or similar to known illegitimate or questionable sites.

While in one embodiment, the aforementioned databases may be maintained on the server-side (e.g., on remote server 20), it should equally be appreciated that one or more of these databases may similarly be maintained on the client-side (e.g., on user computer 40). While the following process makes certain assumptions about where the databases are maintained, it should be appreciated that one portion of these databases may be maintained on the server-side, while another portion is maintained on the client-side, as well as combinations thereof.

Process 300 begins at block 305 where greenlist and/or blacklist resources are options preloaded into the user system. In one embodiment, this is done to improve efficiency and reduce the processing overhead of implementing the invention.

At block 310, a navigation request is received and processed by the system of the present invention. This navigation request may comprise a pointer to an online resource. In one embodiment, this navigation request comprises a URL entered by a user into an Internet browser application executing on a user computer. In other embodiments, the pointer may comprise a website address at which the requested resource is located, a uniform resource identifier (“URI”), a file transfer protocol (“FTP) address or the like.

As previously mentioned, the program code and data for performing the navigation operation may be provided on the client-side or on the sever-side. In the case of a client-side implementation, the invention may be implemented as a browser add-in, a browser helper object, a layered service provider (LSP), a software driver, network drivers, a separate hardware device or integrated into the browser itself, or any other method to build application, extensions, plug-ins, script, etc. on the platform.

Regardless of the implementation, once the navigation request is received, process 300 may continue to block 315 where a cached greenlist database is queried to see if the pointer for the requested resource is listed. In one embodiment, the cached greenlist contains a list of resources identified as legitimate during the current user session. As previously mentioned, this is but one embodiment and the cached greenlist may similarly be maintained on the client-side or on the server-side, in whole or in part.

If a determination is made at block 320 that the requested resource (or its pointer) is indeed listed in the greenlist database, process 300 may continue to block 322 where access is permitted to the resource (e.g., web page). If, on the other hand, the pointer/resource is not listed, then process 300 will move to block 325.

At block 325, a query of a cached blacklist may be made. In one embodiment, the cached blacklist contains a list of resources developed during the current user session that are known or suspected of being used for illegitimate purposes. As previously mentioned, this is but one embodiment and the cached blacklist may similarly be maintained, in whole or in part, on the client-side or on the server-side.

If a determination is made at block 330 that the requested resource (or its pointer) is indeed listed in the blacklist database, then process 300 will move to block 332 where the user may be notified of the potential problem with the requested resource. If, on the other hand, the requested resource is not listed in the cached blacklist, then process 300 will continue to block 335 of FIG. 3B.

At block 335, a pattern matching operation may be performed. In one embodiment, this operation consists of checking a list of suspicious characteristics against the provided pointer (e.g., URL). Many suspicious online resource pointers contain common characteristics that enable them to be potentially identified. These patterns are usually attempts to disguise the pointer's true destination and/or to masquerade as a legitimate destination. Some characteristics of suspicious pointers are listed below. While these characteristics assume the resource is a web page and that the pointer is a URI, it should equally be appreciated that pointers for other types of online resources tend to exhibit telling characteristics as well.

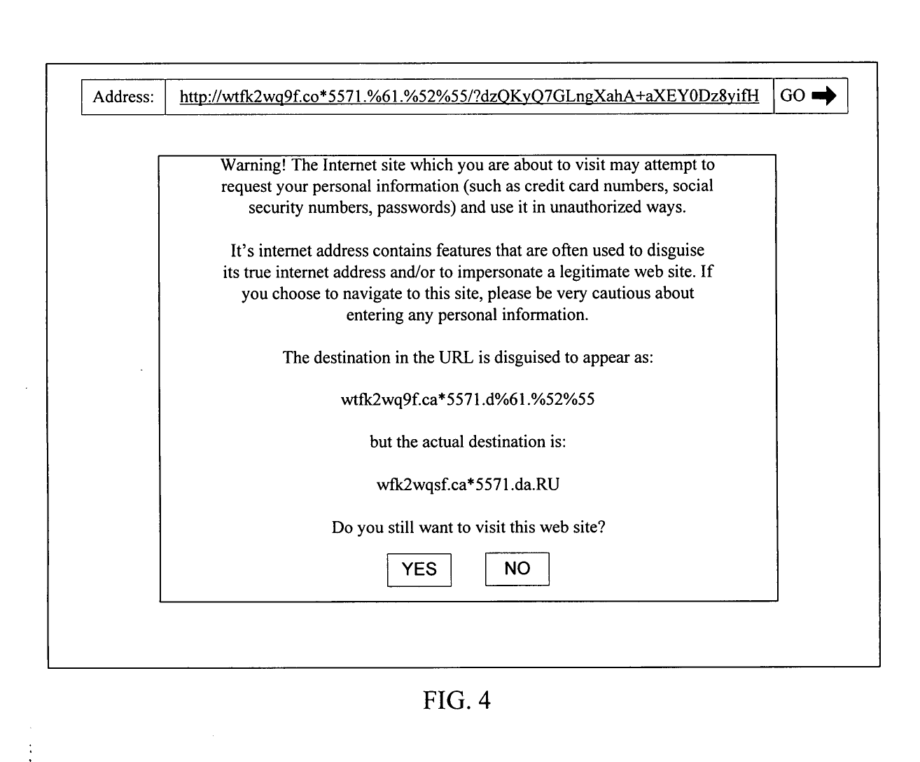

Encoded Host Names: Encoded host names are usually an attempt to disguise the real host name via obfuscation. FIG. 4 contains one embodiment of a graphical user interface displaying a warning that the user is attempting to access such a website.

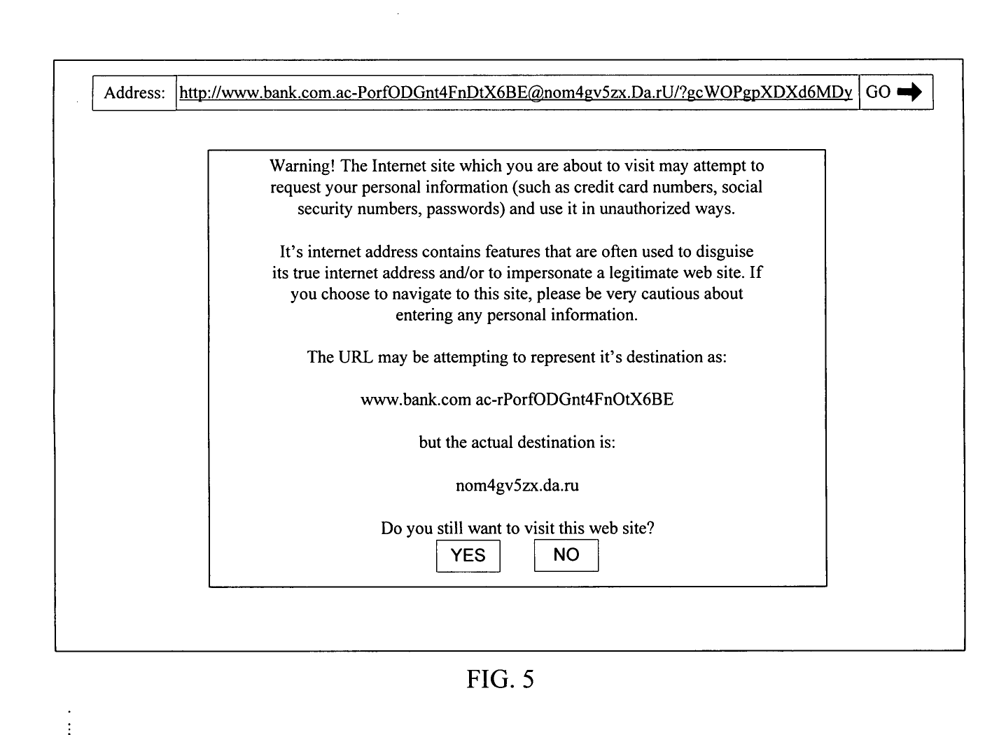

Authentication-format URLs: These deceptive URLs use the authentication (i.e. username and password) capability in an URL in an attempt to disguise the real site as a legitimate site. For example, on casual observation, the URL: http://www.citibank.com:ac-tX6BEΩnom4gv5zx.Da.rU/?gcWOPgpXDXd6MDy seems as if it will navigate to citibank.com but the true host name is nom4gv5zx.da.ru. FIG. 5 contains one embodiment of a graphical user interface displaying a warning that the user is attempting to access such a website.

Raw IP addresses: Many times an attempt to disguise the true destination is made by not using a host name but instead only providing a raw IP address. For example, http://216.109.118.74/.

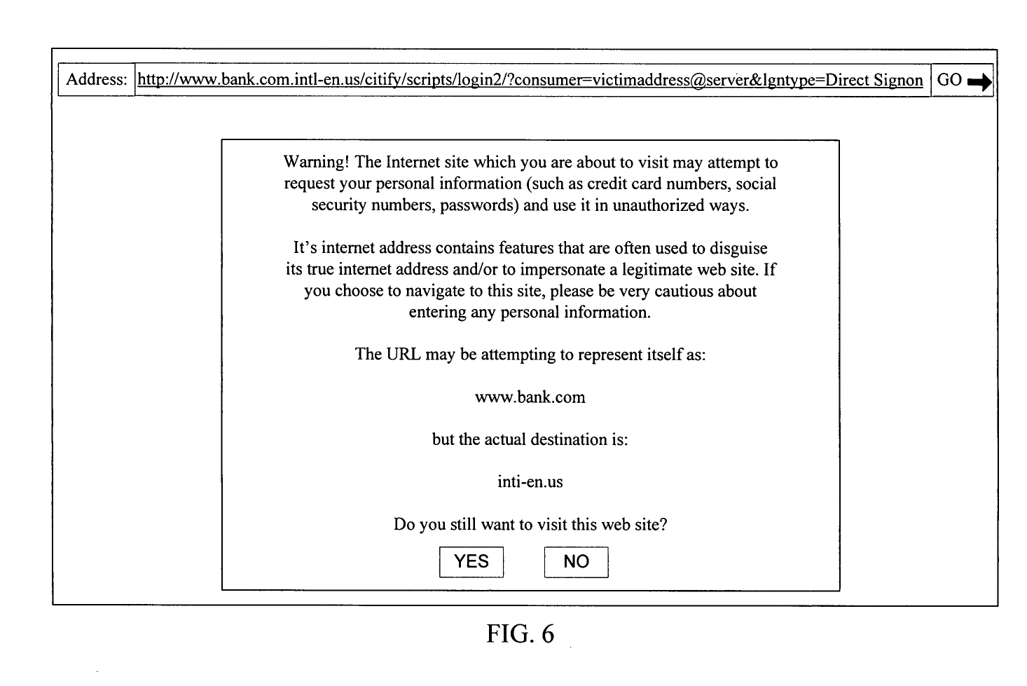

Embedded Top Level Domain plaintext host name spoof: These deceptive URLs include, for example, an embedded “.com.” or “.com-” in an attempt to trick a casual observer. For example, http://www.bank.com.intl-en.us/logi.n2/?-consumer=victimaddress@server&lantype=Direct Simon may appear as if it will navigate to bank.com, but the real host is intl-en.us. FIG. 6 contains one embodiment of a graphical user interface displaying a warning that the user is attempting to access such a website.

Embedded Target plaintext host name spoofs: These deceptive URLs embed a target name in a second-level or higher domain e.g. “yahoo-billing.com” or “paypal.phisher.info”.

In one embodiment, the pattern matching operation of block 335 includes raw (i.e., unprocessed) pointer, encoded and decoded pointers (e.g., URLs) and canonicalized or uncanonicalized pointers. That is, a pointer can be encoded and canonicalized, decoded and canonicalized, encoded and uncanonicalized, or decoded and uncanonicalized, or unprocessed. In addition, while the entire pointer may be checked against known patterns, in another embodiment only a portion of the pointer (e.g. the host name) may be used.

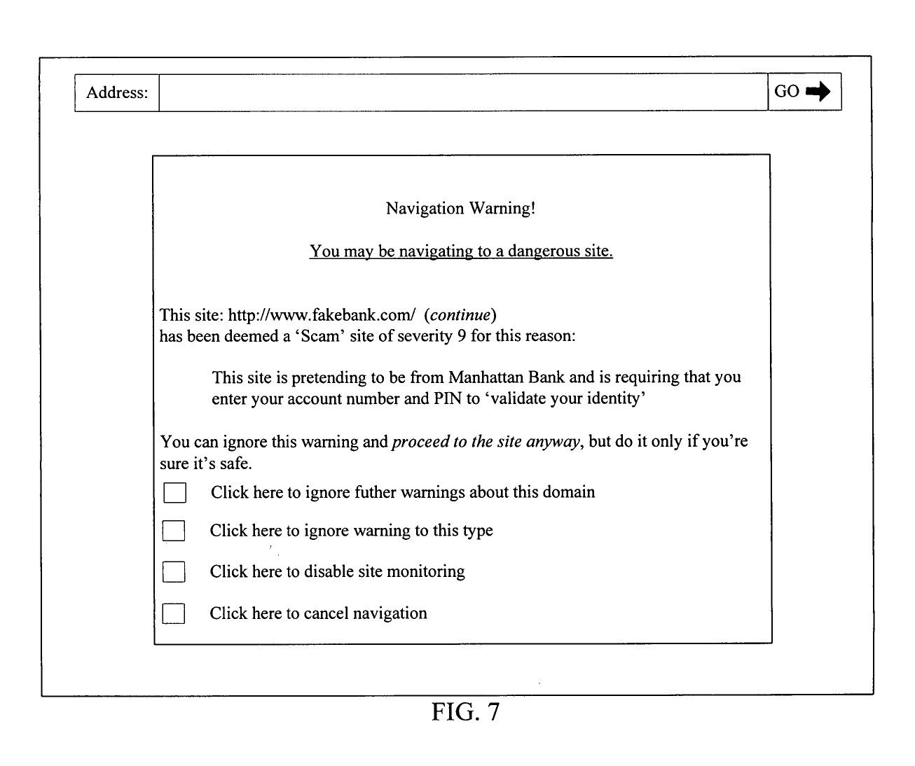

If a determination is made at block 340 that the pointer (or portion checked) matches a suspicious pattern or contains suspicious characteristics, then process 300 continues to block 345. At block 345 an exceptions list may be consulted to determine if the provided pointer, although exhibiting suspicious characteristics, is actually associated with a legitimate resource. If the pointer (or resource) is not identified as legitimate, then the user will be warned of the possible problem with the requested resource at block 347. Alternatively, access may simply be prevented or other action taken. In one embodiment, this warning is in the form of a web page to which the user's browser is automatically directed. FIG. 7 depicts one embodiment of such a warning page that uses an LSP implementation.

In another embodiment, each suspicious category or characteristic (as determined at block 340) could have its own exceptions database or databases. In this fashion, system performance may be increased since characteristic-specific databases would be smaller than a general exceptions list.

If, on the other hand, there is no pattern match at block 340, or it is determined at block 345 that the provided pointer is listed in the exceptions database, then process 300 will continue to block 350.

At block 350, a locally maintained greenlist database may be queried to see if the pointer for the requested resource is listed. In one embodiment, the local greenlist contains a list of resources identified as legitimate (which may include characteristics thereof), which is downloaded to the user system. As previously mentioned, however, the greenlist database may be maintained on the client-side, may be cached, may be maintained on the server-side, or any combination thereof.

If a determination is made at block 355 that the requested resource (or its pointer) is indeed listed in the local greenlist database, process 300 may continue to block 360 where the requested resource is displayed to the user. If, on the other hand, the pointer/resource is not listed, then process 300 will move to block 365.

At block 365, a query of a locally maintained blacklist may be made. In one embodiment, the cached blacklist contains a list of resources which has been downloaded to the user system and which contains known or suspected illegitimate resources. As previously mentioned, this is but one embodiment and the local blacklist may similarly be maintained, in whole or in part, on the client-side or on the server-side.

If a determination is made at block 370 that the requested resource (or its pointer) is indeed listed in the local blacklist database, then process 300 will move to block 375 where the user may be notified of the potential problem with the requested resource, or provided with other resolutions that are known to those of skill in the art, e.g., blocking access to the requested resource. If, on the other hand, the requested resource is not listed in the local blacklist, then process 300 will continue to block 380 of FIG. 3C.

Referring now to FIG. 3C, block 380 involves a determination as to whether a real-time query should be performed for the requested resource prior to permitting the user to access it. In the embodiment, the first step in a real-time query is to submit the pointer of the desired online resource for approval or disapproval at block 380. In one embodiment, this may involve client-side software submitting the pointer to a server-side application. In one embodiment, real-time queries may be performed randomly; at the user's direction; for all requested resources; for only a portion of all requested resources; or for any combination thereof.

If a real-time query is to be performed, process 300 will continue to block 385 to determine if the requested resource should be blocked (or at least a warning provided), or other resolution provided.

If a determination is made at block 385 that the requested resource (or pointer) is to be blocked, then this resource may be added to a blacklist at block 400. According to one embodiment, the user may be presented with a warning regarding the requested resource. For example, in one embodiment the real-time database may indicate that the requested resource is a newly discovered illegitimate resource not yet added to the blacklist database. In this case, the user may be provided with the appropriate warning (e.g., warning screen of FIG. 7) at block 405 prior to allowing access or providing some other resolution to the request.

However, if it is determined at block 385 that the requested resource is not listed in the real-time database, then process 300 may continue to block 390 where the resource in question may be added to the greenlist database. Thereafter, at block 395 the requested resource may be accessed without further interruption.

In addition to the forgoing, it should further be appreciated that automatic or voluntary reporting of detected illegitimate online resources by individual users may be allowed. Users may also be permitted to augment the exceptions list as well. In another embodiment, the ability to report a resource (or pointer), whether as an illegitimate or legitimate resource, may be performed using a web-based email application.

Another detection possibility for the client could be to detect “address bar hijacking”. In this type of attack, the real browser address bar is suppressed, and a new address bar is created using JavaScript and frames. The new address bar may make it appear as if the user is visiting a legitimate site.

In yet an additional embodiment, the context of the provided pointer or requested resource may be analyzed to evaluate its legitimacy. The presence of context information for the provided pointer can identify attempts to misrepresent the actual pointer (e.g., URL). Where the context for the provided pointer is in HTML, for example, the anchor tag may be analyzed. In one embodiment, the text in the anchor tag may be compared to the anchor tag's actual link and analyze it for possible misrepresentation. For example, the hyperlink for the anchor tag might appear to the user as http://ebay.com/AccountConfirmation.html, with the actual link being http://Phishingjnc.com/StealCreditCardNumber.html. This attempted misrepresentation would be detected by analyzing the URL's context, e.g., through the use of heuristics.

Additionally, the length of time that the requested resource has been registered, or otherwise in operation, may also be analyzed. This may be significant since many illegitimate resources are fly-by-night operations that are setup quickly, gather information for a few days or weeks, and then shut down.

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for providing online protection to a user, the method comprising:
receiving a request for an online resource from the user;
determining if the requested resource is in a list of legitimate resources;
if the requested resource is in the list of legitimate resources, allowing access to the requested resource;
if the requested resource is not in the list of legitimate resources, determining if the requested resource is in the list of illegitimate resources; and
if the requested resource is in list the illegitimate resources, displaying warning message to the user indicating that the requested resource is illegitimate.

2. The method of claim 1, wherein receiving a request for an online resource comprises receiving a pointer to the online resource.

3. The method of claim 2, wherein the pointer is selected the set of pointers including: a uniform resource identifier (“URI”), a uniform resource locator (“URL”) and a file transfer protocol (“FTP”) address.

4. The method of claim 2, comprising determining whether the pointer to the requested online resource exhibits one or more characteristics of an illegitimate resource.

5. The method of claim 4, comprising comparing one or more characteristics of the pointer to the requested online resource with one or more characteristics of illegitimate resources selected from a group of characteristics including: an encoded host name, an authentication-format URL, a raw IP address, an embedded top-level domain name, and an embedded targeted plaintext host name.

6. The method of claim 1, comprising storing the lists of legitimate and illegitimate resources in a memory on a computer.

7. A system for providing online protection to a user, the system comprising:
one or more data structures listing one or more legitimate resources, one or more illegitimate resources and one or more characteristics of illegitimate resources; and
a processor operative to receive a user request for an online resource, determine whether the requested resource is listed in the legitimate resources and illegitimate resources, and conditionally provide access to the requested online resource on the basis of the presence of the online resource in one of the legitimate resources and illegitimate resources.

8. The system of claim 7, wherein a request for an online resource comprises a pointer to the requested online resource.

9. The system of claim 8, wherein the pointer is selected from the set of pointers including: a uniform resource identifier (“URI”), a uniform resource locator (“URL”) and a file transfer protocol (“FTP) address.

10. The system of claim 9, wherein the processor is operative to determine whether the pointer to the requested online resource exhibits one or more characteristics of an illegitimate resource.

11. The system of claim 10, wherein the processor is operative to compare one or more characteristics of the pointer to the requested online resource with one or more characteristics of illegitimate resources selected from a group of characteristics including: an encoded host name, an authentication-format URL, a raw IP address, an embedded top-level domain name, and an embedded targeted plaintext host name.

12. The system of claim 7, wherein the data structure is stored remotely from the processor.

13. The system of claim 7, wherein the data structure is stored locally to the processor.

14. A method for providing online protection to a user, the method comprising:
receiving a request for an online resource from the user, wherein the request comprises a pointer to the requested online resource;
determining whether the pointer to the requested online resource exhibits one or more characteristics of an illegitimate resource;
if the pointer exhibits one or more characteristics of an illegitimate resource, determining if the requested resource has been determined legitimate; and
if the requested resource has not been determined legitimate, displaying a warning message to the user indicating that the requested resource may be illegitimate.

15. The method of claim 14, comprising providing user access to the requested resource if the pointer does not exhibit one or more characteristics of an illegitimate resource.

16. The method of claim 14, wherein determining if the requested resource has been determined legitimate comprises determining if the requested resource is in an exceptions list, wherein the exceptions list comprises pointers to the resources having characteristics similar to illegitimate resources but that have been determined legitimate.

17. The method of claim 14, wherein determining whether the pointer to the requested online resource exhibits one or more characteristics of an illegitimate resource comprises comparing one or more characteristics of the pointer to the requested online resource with one or more characteristics of illegitimate resources.

18. The method of claim 17, wherein comparing comprises selecting one or more characteristics of illegitimate resources from the set of characteristics including: an encoded host name, an authentication-format URL, a raw IP address, an embedded top-level domain name, and an embedded targeted plaintext host name.

19. The method of claim 14, wherein the pointer is selected from the set of pointers including: a uniform resource identifier (“URI”), a uniform resource locator (“URL”) and a file transfer protocol (“FTP”) address.

20. Computer readable media comprising program code operative to instruct a programmable processor to execute a method for providing online protection to a user, the computer readable media comprising:
program code for receiving a request for an online resource from the user, wherein the request comprises a pointer to the requested online resource;
program code for determining whether the pointer to the requested online resource exhibits one or more characteristics of an illegitimate resource;
if the pointer exhibits one or more characteristics of an illegitimate resource, program code for determining if the requested resource has been determined legitimate; and
if the requested resource has not been determined legitimate, program code for displaying a warning message to the user indicating that the requested resource may be illegitimate.

21. The computer readable media of claim 20, comprising program code for providing user access to the requested resource if the pointer does not exhibit one or more characteristics of an illegitimate resource.

22. The computer readable media of claim 20, wherein the program code for determining if the requested resource has been determined legitimate comprises program code for determining if the requested resource is in an exceptions list, wherein the exceptions list comprises pointers to the resources having characteristics similar to illegitimate resources but that have been determined legitimate.

23. The computer readable of claim 20, wherein the program code for determining whether the pointer to the requested online resource exhibits one or more characteristics of an illegitimate resource comprises program code for comparing one or more characteristics of the pointer to the requested online resource with one or more characteristics of illegitimate resources.

24. The computer readable media of claim 23, wherein the program code for comparing comprises program code for selecting one or more characteristics of illegitimate resources from the set of characteristics including: an encoded host name, an authentication-format URL, a raw IP address, an embedded top-level domain name, and an embedded targeted plaintext host name.

25. The computer readable media of claim 20, wherein the program code for receiving the request for the online resource comprise program code for receiving pointer selected from the set of pointers including: a uniform resource identifier (“URI”), a uniform resource locator (“URL”), a file transfer protocol (“FTP”) address.
